(19) United States
(12) Patent Application Publication
(10) Pub. No.: US 2002/0091769 A1
(43) Pub. Date: Jul. 11, 2002

(54) Conferencing method

(76) Inventors: Piotr Jozef Drozdzewicz, Broomfield, CO (US); William Paul Ernstrom, Golden, CO (US)

Correspondence Address: DORR CARSON SLOAN & BIRNEY, PC, 3010 EAST 6TH AVENUE, DENVER, CO, 80206

(21) Appl. No.: 10/043,719

(22) Filed: Jan. 9, 2002

Related U.S. Application Data
(60) Provisional application No. 60/261,141, filed on Jan. 11, 2001.

(51) Int. Cl. G06F 15/16

(52) U.S. Cl. 709/204; 709/218

(57) ABSTRACT

The method of the present invention establishes a conference among a plurality of participants and a subscriber. The subscriber is assigned a unique URL by a conferencing system. When the subscriber sets up a conference, the subscriber delivers the unique URL to each of a plurality of participants prior to the conference such as by email distribution. Upon activating the delivered URL, each end-user (i.e. the subscriber and participants) provides the necessary endpoint (i.e., a telephone number) identity information to enable it to participate in the upcoming conference. The conferencing system then sets up the conference based upon all of the entered endpoint identification submitted.

### RELATED APPLICATION

This patent application claims the benefit of, including the filing date of, Provisional Application No. 60/261,141, entitled “One-Click Online Conference Calls”, filed Jan. 11, 2001.

### BACKGROUND OF THE INVENTION

1. Field of the Invention

The present invention relates to conference calls and, more particularly, to conference calls initiated online such as on the Internet.

2. Background

A need exists for simplifying the process for setting up a conference call, in real time, over a communications network. A further need exists for using an online communication network such as the Internet in placing such conference calls.

An example of one conventional, online conferencing method is provided by Latitude Communications which is trademarked MEETINGPLACE. In this system, users schedule and attend voice and data conferences using MICROSOFT OUTLOOK client. This requires expensive software to be added at the customer site. Participants to a conference are automatically sent a message containing meeting and attendance information. Attending the conference occurs by clicking on an attendance URL and picking up a telephone.

In US printed patent application publication number US 2001/0016038 A1, a personal web-based teleconferencing method and system is set forth. In this online approach, the user starts the conference process by listing his/her name, phone number and each participant by name and phone number in a screen form delivered to it by a WWW server. This is then delivered to the server and the user then fills out the credit card information. The user receives an icon not only for himself/herself, but also for each participant. The user begins the conference call by connecting him/herself to the teleconference by clicking on a supplied icon. The user then sequentially accesses the icon of each participant to join that participant into the conference call.

A need exists for an easy-to-use, from the viewpoints of both the subscriber setting up the conference and each participant, method for setting up a conference in an online environment. A need also exists to accomplish this method without providing expensive resident software at the subscriber's (and/or participant's) site. A need exists to set up the conference through the conventional telecommunications system wherein the subscriber and participants select any suitable communication endpoints, such as a telephone, at the time of the conference. Finally, a need exists to set up a conference in such a way that conference system resources are not locked or reserved for the conference and, therefore, become unused when fewer people join the conference than were expected.

### SUMMARY OF THE INVENTION

The method of the present invention establishes a conference call among a plurality of participants and a subscriber. The subscriber is assigned and provided a unique URL by a conferencing system. When the subscriber requests a conference call at a set time, the subscriber delivers the unique URL to each of a plurality of participants prior to the conference call such as, for example, by email distribution. Upon clicking on the delivered URL at the set time for the conference, each participant provides the necessary endpoint identity information (i.e., a telephone number) to the conferencing system. The conferencing system then connects the participant into the conference by calling the provided endpoint.

### BRIEF DESCRIPTION OF THE DRAWINGS

FIG. 1 is a global diagram showing the iconic hyperlink creation and distribution method of the present invention.

FIG. 2 is a global flow diagram showing the method for providing conferencing in the present invention.

FIG. 3 is a flow chart for the present invention.

FIG. 4 is an embodiment of a subscriber database.

### DETAILED DESCRIPTION OF THE INVENTION

1. Overview.

The following definitions are used herein with respect to the figures:

Communication System 10—A system that allows end-users to share information (voice, video, data, . . . ) with each other. Examples of a communication system include conventional telephone networks and the Internet.

Conferencing System 120—A conferencing system allows multiple participants to share data with other participants simultaneously in a conference in a communication system 10. The data to be shared includes voice, video, a combination thereof or any other form of data. The type of data being shared in the conference is not germane to the teachings of the present invention.

Service Provider—The owner and/or operator of the conferencing system 120 who provides conferencing services to end-users.

Subscriber 100—The end-user who has obtained conferencing services from the service provider. The subscriber “owns” a conference account and is typically responsible for paying for conferencing services. The subscriber may be an individual person, a legal entity such as a corporate body, or some other entity such as a group of individuals.

Participant(s) 130—End-users other than the subscriber 100 who join in a conference with a subscriber 100. Participants 130 typically do not own a conference account with the service provider. The list of participants who join in a conference is completely variable and does not need to have any commonality from conference to conference.

Endpoint 100b, 130b—The communication device used by the subscriber 100 and participant 130 to transmit and receive data to/from the conference. In the case of an audio conference this device is typically a telephone. The type of endpoint used is conventional and is not germane to the present invention and includes, but not limited to, a cell phone, a web browser, etc.

Conference Platform 140—The component of the conferencing system 120, to which the data sharing network connects. A conferencing system 120 includes one or more conferencing platforms 140.

Web Server 110—The service provider runs a web server that is accessible to end-users. This access is typically done via the public Internet 30 for users outside the service provider's enterprise. This web server 110 provides external access to the conferencing system 120 via standard web browsers, and communicates to the conferencing system 120 via various Application Programming Interfaces (APIs).

Access Codes—An identifying code used by the subscriber 100 and all participants 130 to connect to the conferencing system 120. The complete set of access codes identifies which conference end-users 130 are to be joined to a conference call. In the case of audio-conferencing, these access codes are typically a dialed telephone number along with a series of Dual Tone Multi-Frequency (DTMF) digits that are entered once a connection is established with the conferencing system 120.

All of the above definitions are conventionally known and the systems and components thereof are conventionally found in one form or another. In U.S. Pat. No. 6,181,786, for example, one conventional teleconferencing system is set forth. The present invention, as discussed in the following, incorporates those definitions.

2. Creating and Distributing a URL Hyperlink 120 to the Subscriber 100

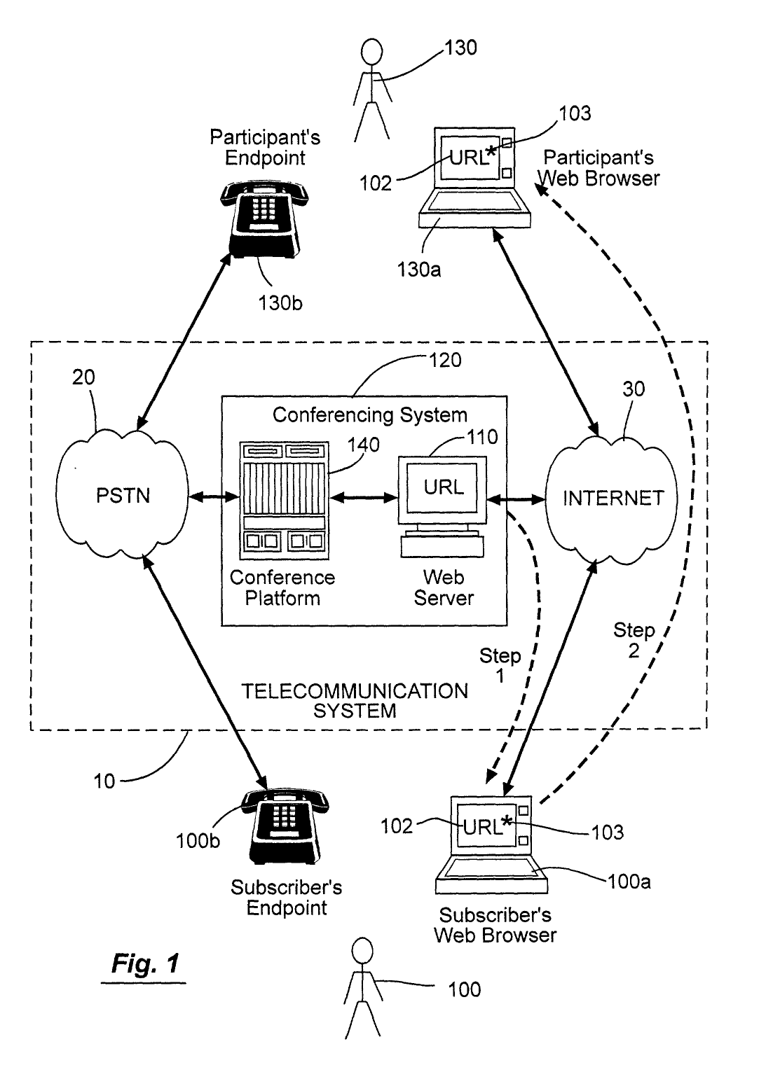

The ironic hyperlink creation and distribution of the present invention is shown in FIG. 1. An embodiment of a telecommunication system 10 is shown utilizing conventional PSTN 20 and Internet 30 components.

A new or existing subscriber 100 is given access to conferencing services in conferencing system 120 via the conferencing access method of the present invention. Using account information for the subscriber 100, a Universal Resource Locator (URL) hyperlink 102 is defined which uniquely identifies the subscriber 100. The URL 102 when accessing the Internet 30 points to the web server 110 connected to the conferencing system 120, and uniquely identifies that subscriber 100 to the conferencing system 120.

The URL 102 created is a unique hyperlink for each subscriber 100 on the conferencing system 120. The URL 102 is mapped within the conferencing system 120 (or external devices connected to the conferencing system 120) to identify the subscriber 100 just as that subscriber's conventional unique access codes do.

The process by which the URL hyperlink 102 is created may be initiated many different ways, manually or automatically, and is not defined as part of the present invention. The URL 102 hyperlink may be optionally combined with a graphical icon 103.

The URL 102 (with optional graphical icon 103) is distributed to the subscriber 100 by the conferencing system 120. The distribution method is up to the service provider and is not defined or restricted within the scope of the present invention. Distribution methods which provide the URL 102 to the subscriber 100 include: as an attachment to an email sent to the subscriber from the conferencing system 120 (or agent of the system 120), placed on a web page where the subscriber may access and copy it (as illustrated as Step 1, FIG. 1), etc.

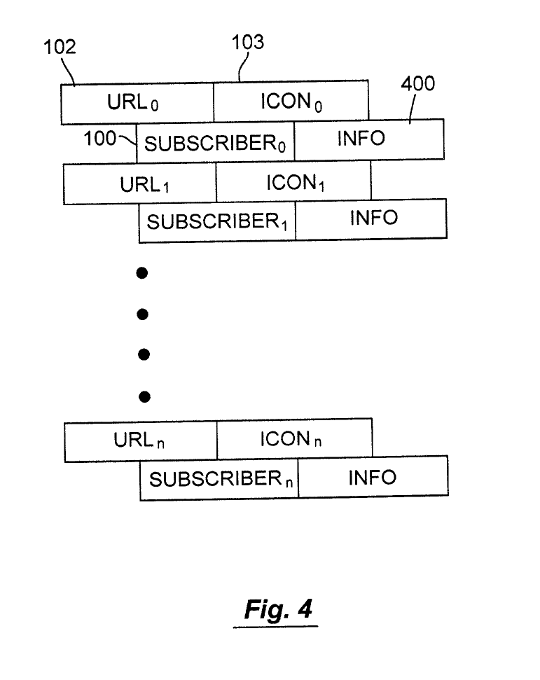

In FIG. 4, an embodiment of a database that uniquely identifies a subscriber to a URL 102 is shown. In FIG. 4, the URL 102 also has an associated icon 103, which, under the teachings of the present invention, is optional. In FIG. 4, each subscriber 100 is identified as well as information concerning that subscriber such as found in the information field 400. This field 400 includes any conventional information such as charging requirements, billing requirements, etc. Field 400 can also include the complete history of all conference calls made by the subscriber 100 in the past. It is to be expressly understood that the database configuration in FIG. 4 is but one embodiment and that many different database configurations could be used without limiting the teachings of the present invention.

The URL link 102 identifies the subscriber 100, not a specific conference. The subscriber 100, i.e. the holder of the conferencing account can access the conferencing system 120 at any time. The URL 102, in one embodiment of the present invention, can be used by the subscriber 100 for any number of conferences at any set times.

3. Distributing the Hyperlink 102 to the Participants 130.

The method for distributing the hyperlink 102 to participants 130 is shown in FIG. 1. The subscriber 100 then makes the URL hyperlink 102 (and/or graphics 103) accessible to potential participants 130 of a conference call. Distribution is done by a number of different embodiments: by placing on a web page accessible to participants, as an attachment to an email sent to participants, or by some other means. The actual form of the delivery mechanism for the URL hyperlink 102 is not germane to the present invention (as illustrated as Step 2, FIG. 1).

4. Entering a Conference.

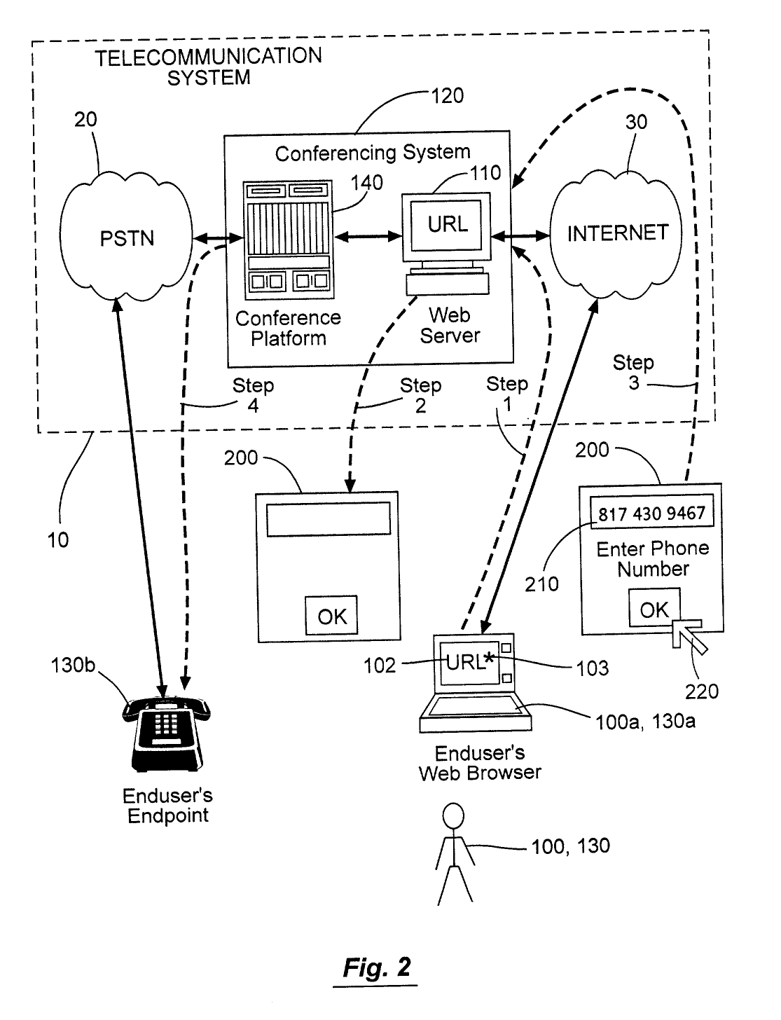

The method of the present invention for entering a conference is shown in FIG. 2. A participant 130 wishes to join a conference and clicks on the distributed URL hyperlink 102 (or icon 103) representing the subscriber's account, which will host the conference (as illustrated as Step 1, FIG. 2).

The web server 110 responds to the URL 102 request by delivering to the web browser 130a of the end-user 130 a page/frame (or any other suitable information) 200 that asks that the participant 130 enter information that identifies how the conferencing system 120 can connect to the end-user's endpoint 130b (as illustrated as step 2 in FIG. 2). In the case of audio conferencing, the information 200 is typically the telephone number 210 of telephone 130b on which the participant 130 wishes to use in order to participate in the conference. The participant 130 enters his/her endpoint identification 210 and acknowledges 220 that it has been entered (as illustrated as Step 3, FIG. 2). The clicking on acknowledgment 220 causes the endpoint identity information 210 to be provided to the conferencing system 120 through the Internet 30.

The conferencing system 120 responds to the request in Step 3 by connecting to the endpoint 130b using the supplied identification information 210. In the case of audio conferencing, this is typically done by having the conferencing system 120 dial out to the phone number 210 entered by the end-user 130 through the PSTN 20 of the telecommunication system 10 to ring the telephone. When the telephone goes off-hook, the end-user 130 is connected to the conference through the telecommunication system 10.

The end-users (i.e., the subscriber 100 and all participants 130) use the same hyperlink 102 (and/or with optional icon 103). Multiple end-users 130 may activate the hyperlink 102 (Step 2) concurrently, and will all be processed as unique and independent entrants to the same conference. At the time of the conference, end-users can be anywhere. Under the teachings of the present invention, each end-user can enter endpoint identity information 210 that is most convenient. By way of example, each of four end-users for a conference may be at the following different locations at the set time for the conference: End-user A is at his office and enters his office phone number, end-user B is at her office and enters her cell phone number, end-user C is at home and uses the softphone in her computer through a soft phone icon 20, and end-user D is at the airport and, using a computer at a kiosk, enters his cell phone number.

Neither the subscriber 100, nor the creator of the URL 102 (conferencing system 120), determines what type of endpoint will be specified when the URL 102 is used by end-users of the URL 102. These end-users select the endpoint identification data 210 to enter at the time they wish to be connected. The URL 102 can also specify different types of endpoints 100b, 103b, for each end-user. One may select a desk phone, another a cell phone, and still another a pay phone.

The above process also applies to the subscriber 100. Hence, the subscriber 100 just before the set time for the conference clicks on the URL 102 and is delivered the page/frame 200 to fill out the necessary information. This allows the subscriber, at the time of the conference, to be at any suitable location and not locked in to a specific endpoint 100b nor a requirement that it be set up in advance.

The phrase “at the time of the conference” is used functionally to indicate the time of occurrence, in a general sense, of the conference. While the conference can be scheduled by the subscriber 100b for a “set time” (i.e., 9 a.m.), the conference can be accessed by the end-users at the set time which includes accessing before, precisely at the set time, or after the set time. Further, the conferencing system 120 does not need a reservation for the “set time”. The URL 102 is active all the time. The subscriber 100 and the participants 130 can decide when (and that can be at anytime) to have a conference.

5. Flow Chart and Examples.

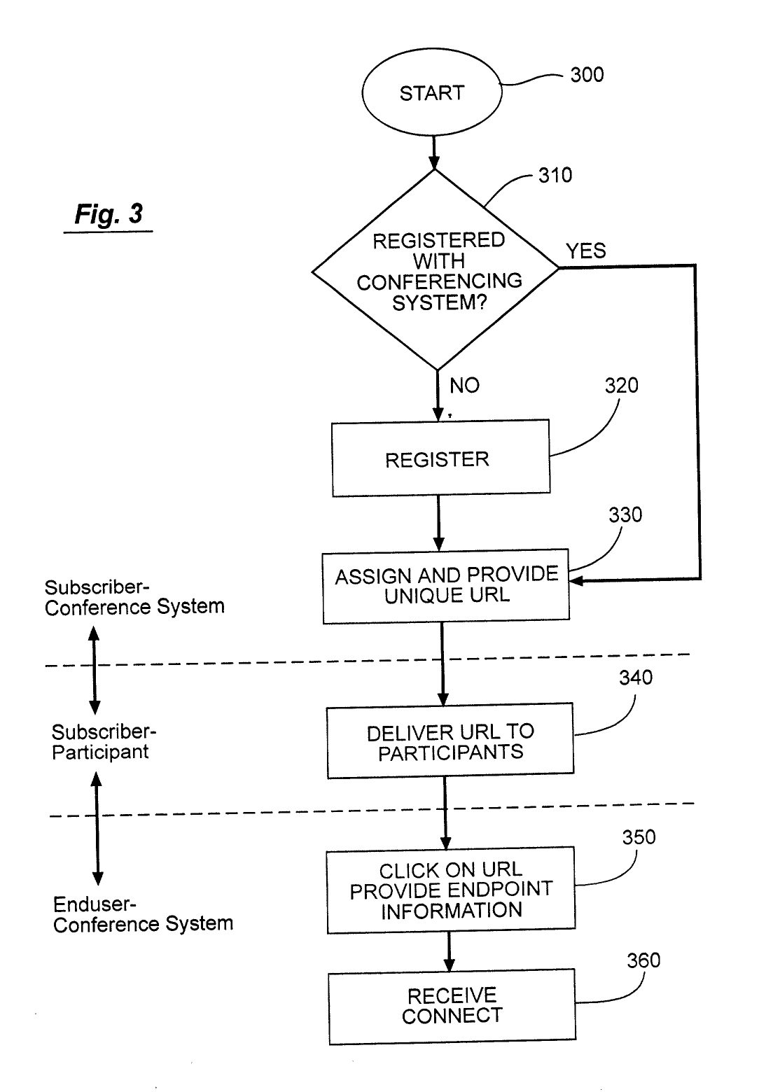

In FIG. 3, another representation of the method of the present invention is set forth. The method starts 300 by the subscriber 100 conventionally initially accessing with the conference system 120. In stage 310, if the subscriber 100 is already registered with the conferencing system, then stage 330 is entered. If not, the subscriber 100 in stage 320 registers with the system 120 which also occurs in a conventional fashion for conferencing systems 120. The subscriber 100 provides all necessary information including charge information, maximum size of conference permitted, etc. The present invention is not limited as to how a subscriber accesses and/or registers with the conferencing system 120 in stage 320.

In stage 330, the subscriber 100 is assigned in the web server 110 a unique URL 102 and/or any associated graphical icon 103. In the conferencing system 120, the subscriber 100 is now fully identified with the URL 102 and/or graphical icon 103. It is to be understood that the URL 102 (or icon 103) can be the same for the subscriber 100 for all conferences. Of course, if the subscriber requires a different URL, then a different URL can be assigned. The web server 110 provides the assigned unique URL through the Internet 30 to the subscriber 100.

Before a conference is to be held, the subscriber 100 distributes the URL 102 in stage 340 to all participants 130 to the conference call. This occurs in a fashion already described such as, but not limited to, by email distribution. In stage 350 the participants 130 receiving the URL 102 (and/or icon 103) will click on the distributed URL 102 and then be asked to provide the necessary endpoint information 210 in order to participate in the conference call. The conferencing system 120 receives the provided endpoint information 210 in stage 360 and at the set time of the conference connects all participants 130 and the subscriber to the conference.

A conference is activated when the conferencing system 120 receives the first access on the subscriber's URL 102 over the Internet 30 in the telecommunication system 10 from an end-user whether it be the subscriber 100 or a participant 130. The endpoint identity information 210 filled out for the first access is used by the conferencing system to set up the necessary bridges in the conferencing platform 140 and to connect that first end-user to the conference. Each subsequent end-user accessing the web server 110 of the conferencing system 120 by clicking on the subscriber's URL 102 (or icon 103) is requested 200 to provide the endpoint identity information 210 and the identified endpoint 100b, 130b is then called and when answered connecting the endpoint to the conference. It is well known how to set up conferences in a conferencing system 120 and then to connect endpoints of end-users to the conference.

For example, the subscriber 100 wants to have a conference call with participants A, B, C, and D on Monday at a set time of 9:00 a.m. The subscriber 100 distributes 340 his/her unique URL 102 to participants A, B, C, and D advising them of the 9:00 a.m. conference call. The conferencing system 120 has no “reservation data” for this conference. Should an individual participant 130 wish to participate in a conference call, the subscriber 100 clicks on the unique URL 102 (and/or icon 103) at 9:00 a.m. and provides endpoint information 210 describing how they could be contacted for that call. End-users (i.e., subscriber 100 and participants 130) click the URL when they want the system to call them, not before. If they want to join five minutes early, they would click at 8:55. If they want to join right at 9:00 a.m., they click at 9:00 a.m. If they want to join five minutes later, they would click at 9:05 a.m.

The method of the present invention leaves it to the end-user to control, in real time, when to be connected to the conference. Clicking the URL is akin to picking up the phone and dialing, it takes place immediately. The first end-user to click on the URL 102 provides the first data to the conferencing system 120 that the subscriber 100 is responsible for an impending conference. All end-users of the link dynamically choose when they wish to click on the URL 102 and join the conference. In the preferred embodiment, it is the telephone 100b, 130b that is called by the conferencing system 120. In another embodiment, a soft-phone running in a PC (e.g. web browser 130a) accesses the conference. Both of these are classified as endpoints.

Once delivery of the URL 102 has been made to participants for a given conference, it is not necessary to re-deliver the URL 102 for future conferences. In the above example, the subscriber concludes the 9:00 a.m. conference by telling “B” and “D” to conference at 2:00 p.m. that same day. At the set time for the next conference the “subscriber”, “B”, and “D” click on the URL 102 and are connected into the 2:00 p.m. conference.

In another example, assume a financial website sets up audio chat rooms to discuss a specific investing topic or to have a consultant available to answer questions. The financial website is the subscriber 100 and through the process discussed in FIGS. 1 and 2 and in stages 300 through 330 has assigned to it a unique URL icon 103. Participants 130 can join the conference at the appropriate time by clicking on the financial website assigned icon and by providing endpoint information. If too many click on the URL 102, that is equivalent to too many participants 130 dialing in. They will be told that the capacity of the system 120 has been exceeded. The limit is defined as the number of participants the subscriber is allowed to have join his/her conference, and is set up when the subscriber 100 is first given access to the conferencing system 120. For example, assume a maximum conference size of 12 participants. If a 13ₜₕ person tried to join the conference, then they would be turned away with a suitable message or recording. The “capacity exceeded” functionality is not unique to the conferencing method of the present invention, but rather is part of the conventional conferencing environment.

The above disclosure sets forth a number of embodiments of the present invention. Those skilled in this art will however appreciate that other arrangements or embodiments, not precisely set forth, could be practiced under the teachings of the present invention and that the scope of this invention should only be limited by the scope of the following claims.

We claim:

1. A method for providing a conference for a subscriber and a plurality of participants at a set time using a conferencing system in a telecommunication system, the telecommunication system incorporating an Internet, the method comprising:
assigning in a web server of the conferencing system a unique URL for the conference of the subscriber,
providing the unique URL through the Internet to a web browser of the subscriber,
delivering the unique URL and the set time through the Internet from the web browser of the subscriber to each of the plurality of participants, the subscriber and the plurality of participants comprising end-users in the conference,
each of the end-users clicking on the delivered URL at the set time to access the web server of the conferencing system through the Internet,
each of the end-users providing endpoint identification information corresponding to an endpoint to the accessed web page,
connecting each endpoint of the end-users to the conference in the conferencing system through the telecommunications system in response to the provided endpoint identification information.

2. The method of claim 1 wherein providing the unique URL occurs by emailing the unique URL through the Internet to the subscriber.

3. The method of claim 1 wherein providing the unique URL comprises:
placing the unique URL on a web page of the web server,
copying of the placed URL by the subscriber from the web page of the web server.

4. The method of claim 1 wherein delivering comprises emailing the unique URL through the Internet to the web browser of each of the plurality of participants.

5. The method of claim 1 wherein delivering comprises:
placing the unique URL on a web page of the subscriber,
copying of the placed URL by the participants from the web page of the subscriber.

6. The method of claim 1 wherein the unique URL is a graphical icon.

7. The method of claim 1 wherein the endpoint is a telephone and wherein the endpoint information is a telephone number for the telephone.

8. The method of claim 7 wherein connecting comprises:
calling the telephone for the telephone number provided in the endpoint identification information,
adding the telephone to the conference when it goes off-hook.

9. A method for providing a conference for a subscriber and a plurality of participants using a conferencing system in a telecommunication system, the telecommunication system incorporating an Internet, the method comprising:
assigning in a database of a web server of the conferencing system a unique URL for the conference of the subscriber,
providing the unique URL through the Internet to a web browser of the subscriber,
delivering the unique URL from the subscriber to each of the plurality of participants, the subscriber and the plurality of participants comprising end-users in the conference,
activating the conference in the conferencing system when the delivered URLs are clicked on by the end-users.

10. The method of claim 9 wherein delivering comprises emailing the unique URL through the Internet to the web browser of each of the plurality of participants.

11. The method of claim 9 wherein delivery comprises:
placing the unique URL on a web page. The web page could be anywhere, owned and operated by anyone.
copying of the placed URL by the participants from the web page of the subscriber.

12. The method of claim 9 further comprising:
each of the end-users clicking on the delivered URL at the set time to access the web server of the conferencing system through the Internet,
each of the end-users providing endpoint identification information corresponding to an endpoint to the accessed web page,
connecting each endpoint of the end-users to the conference in the conferencing system through the telecommunications system in response to the provided endpoint identification information.

13. A method for providing a conference for a subscriber and a plurality of participants at a set time using a conferencing system in a telecommunication system, the telecommunication system implemented with an Internet, the method comprising:
assigning in a web server of the conferencing system a unique URL for the conference of the subscriber,
providing the unique URL through the Internet to a web browser of the subscriber,
delivering the unique URL and the set time through the Internet from the web browser of the subscriber to each of the plurality of participants, the subscriber and the plurality of participants comprising end-users in the conference,
an end-user clicking on the delivered URL at the set time to access the web server of the conferencing system through the Internet,
the end-user providing a telephone number corresponding to a telephone to the accessed web page,
calling the telephone from the conferencing system through the telecommunications system in response to providing the telephone number,
connecting the end-user to the conference when the called telephone goes off-hook.

14. A method for providing conferences in a telecommunication system for a plurality of subscribers, the method comprising:
providing a plurality of URLs in a web server at a conferencing system in the telecommunication system,
assigning in the web server at least one of the plurality of URLs to each of said plurality of subscribers,
activating a conference in the conferencing system when the URL of a subscriber accesses the web server of the conferencing system over the Internet from a web browser of the aforesaid subscriber or of a participant to the conference.

15. The method of claim 14 wherein activating comprises:
receiving endpoint information from the subscriber and from each participant accessing the URL of the subscriber,
connecting each endpoint for each received endpoint information to the conference.

16. The method of claim 15 wherein an endpoint is a telephone and the endpoint information is a telephone number for the telephone.

17. The method of claim 16 wherein connecting comprises calling the telephone number.

18. The method of claim 14 wherein at least one URL has an associated icon.
